(19) United States
(12) Patent Application Publication
(10) Pub. No.: US 2021/0120142 A1
(43) Pub. Date: Apr. 22, 2021

(54) PATTERN GENERATION DEVICE, PATTERN GENERATION METHOD, AND PATTERN FORMING DEVICE

(71) Applicant: SHARP KABUSHIKI KAISHA, Sakai City (JP)

(72) Inventors: MASAYA FUJITANI, Sakai City (JP); TAKASHI KITAGAWA, Sakai City (JP); TOMOE KAYANO, Sakai City (JP)

(21) Appl. No.: 17/070,676

(22) Filed: Oct. 14, 2020

(30) Foreign Application Priority Data
Oct. 21, 2019 (JP) 2019-192269

(51) Int. Cl. H04N 1/23

(52) U.S. Cl. CPC H04N 1/2361; H04N 1/233

(57) ABSTRACT

A pattern generation device includes: a dot pattern generation circuit that generates, with dots each including one pixel and/or a plurality of connected pixels, a tint block pattern by using an adjacent dot pattern to a reproduced pattern where the dots are reproduced when copied and a non-reproduced pattern where the dots are unlikely to be reproduced when copied as compared with in the reproduced pattern; and an output circuit that provides the generated tint block pattern to a printing unit that prints an image, in which the reproduced pattern includes an effective large dot region where the dispersed dots are arranged at a higher space density than in the non-reproduced pattern.

### BACKGROUND OF THE INVENTION

### Field of the Invention

The present invention relates to a pattern generation device, a pattern generation method, and a pattern forming device, and more particularly to a pattern generation device that generates a tint block pattern with dots, a pattern generation method, and a pattern forming device that forms the generated tint block pattern in an image.

### Description of the Background Art

A fine pattern has been arranged as a background on paper surfaces of, for example, banknotes, securities, or ledger sheets. It is for the purpose of emphasizing a taint resulting from afterward erasing or altering a character printed or handwritten on the paper surface to prevent manipulation or forgery. Such a background pattern is also referred to as a tint block.

In recent years, image forming apparatuses such as high-performance copying machines and printing machines have become familiar and, accordingly, a tint block has taken another new role: prevention of copying.

For example, a function to generate a tint block is added to a printing machine that prints and issues identity documents such as resident's cards, tickets, or vouchers, and an identity document, a ticket, or a voucher a background of which is a tint block is printed as an original. The tint block printed on the original includes two regions: a pattern likely to be reproduced when copied by a copying machine (hereinafter, also referred to as “reproduced pattern”) and a pattern unlikely to be reproduced as compared with the reproduced pattern (hereinafter, also referred to as “non-reproduced pattern”).

A copy has a relative difference in concentration between the reproduced pattern and the non-reproduced pattern, which is visually recognized. Accordingly, for example, the reproduced pattern is arranged in the shape of characters “copy” and the non-reproduced pattern is placed in a background region other than the characters. This causes the characters “copy” in the reproduced pattern to appear in the background in the non-reproduced pattern on the copy by virtue of the above-described difference in concentration, allowing the copy to be visually distinguished from the original with a less difference in concentration. An effect in preventing illegal copying is thus obtained. It should be noted that a character in the non-reproduced pattern may be arranged in a background in the reproduced pattern in an inverse manner.

The following technologies regarding tint block patterns for preventing copying are known.

According to one technology, to cause a document to be copied with a character therein less legible so that an effect in preventing copying is enhanced, patterns of a latent portion (a tint block region in a reproduced pattern) and a background portion (a tint block region in a non-reproduced pattern) of a tint block image are changed depending on character size (see, for example, Japanese Unexamined Patent Application No. 2012-109748).

According to another technology, dot sizes of a latent portion (a tint block region in a reproduced pattern) and a background portion (a tint block region in a non-reproduced pattern) of a tint block image are changed using a user interface (see, for example, Japanese Unexamined Patent Application No. 2007-143111).

In order for the original and the copy to be clearly distinguished, the concentrations of the reproduced pattern and the non-reproduced pattern contained in the tint block on the original always have to be almost equal to each other.

However, a fluctuation in the concentration of one pixel that constitutes the pattern due to, for example, a change in the surrounding environment of a printing unit that forms the image or deterioration of a developer sometimes makes a difference in concentration between the reproduced pattern and the non-reproduced pattern in the tint block on the original notable. Otherwise, adjustment sometimes needs to be performed in a printing unit depending on the characteristics of the printing unit to cause the difference in concentration between the reproduced pattern and the non-reproduced pattern to be almost equal to each other.

The present invention has been made in view of the above circumstances and an object thereof to provide a tint block pattern capable of reducing an influence of a difference in concentration between a reproduced pattern and a non-reproduced pattern irrespective of a fluctuation or a variation in pixel concentration.

### SUMMARY OF THE INVENTION

The present invention provides

(1) a pattern generation device including: a dot pattern generation circuit that generates, with dots each including one pixel and/or a plurality of connected pixels, a tint block pattern by using an adjacent dot pattern to a reproduced pattern where the dots are reproduced when copied and a non-reproduced pattern where the dots are unlikely to be reproduced when copied as compared with in the reproduced pattern; and an output circuit that provides the generated tint block pattern to a printing unit that prints an image, in which the reproduced pattern includes an effective large dot region where the dispersed dots are arranged at a higher space density than in the non-reproduced pattern.

Further, the present invention provides

(2) an image forming apparatus including: the pattern generation device; and a printing unit that prints an image including the tint block pattern generated by the pattern generation device.

In another aspect, the present invention provides

(3) a pattern generation method including: by a computer, with use of a pattern generation device, causing the pattern generation device to generate, with dots each including one pixel and/or a plurality of connected pixels, a tint block pattern by using an adjacent dot pattern to a reproduced pattern where the dots are to be reproduced when copied and a non-reproduced pattern where the dots are unlikely to be reproduced when copied as compared with in the reproduced pattern; and causing a printing unit to print an image of the generated tint block pattern, in which the reproduced pattern includes an effective large dot region where the dispersed dots are arranged at a higher space density than in the non-reproduced pattern.

Further, the present invention provides

(4) a pattern forming device including: a dot pattern generator that generates, with dots each including one pixel and/or a plurality of pixels, a tint block pattern having a reproduced region where the dots are reproduced when copied and a non-reproduced region where the dots are unlikely to be reproduced when copied as compared with in the reproduced region, the tint block pattern including a reproduced pattern in the form of a pattern including the plurality of dots and formed in the reproduced region and a non-reproduced pattern in the form of a pattern including the plurality of dots and formed in the non-reproduced region; and an image forming section that forms the generated tint block pattern into an image, in which the reproduced pattern and the non-reproduced pattern include the dots having the same shape, and a dot-to-dot distance in the reproduced pattern is smaller than a dot-to-dot distance in the non-reproduced pattern.

In the pattern generation device according to the above-described (1) of the present invention, the reproduced pattern has an effective large dot region where the dispersed dots are arranged at a higher space density than in the non-reproduced pattern. Therefore, even when the effective large dot region of the reproduced pattern includes the dispersed dots as the non-reproduced pattern and a fluctuation or a variation in the concentrations of the pixels occurs, it is possible to provide the tint block pattern capable of reducing an influence of a difference in concentration between the reproduced pattern and the non-reproduced pattern.

The above-described (2) to (4) according to the present invention achieve similar workings and effects.

### BRIEF DESCRIPTION OF THE DRAWINGS

FIG. 1 is a block diagram illustrating a configuration of a digital multifunction peripheral according to the present embodiment.

FIG. 2 is a perspective view of an appearance of the digital multifunction peripheral illustrated in FIG. 1.

FIG. 3 is an explanatory diagram illustrating an example of one dot including one pixel printed by a printing unit according to the present embodiment.

FIG. 4 is an explanatory diagram illustrating an example of a non-reproduced pattern in which dots illustrated in FIG. 3 are dispersed.

FIG. 5 is an explanatory diagram illustrating a typical reproduced pattern including large dots each including adjacent dots.

FIG. 6 is an explanatory diagram illustrating an example of a reproduced pattern according to the present embodiment.

FIG. 7 is a graph showing a change in the overall concentration of each of the reproduced pattern and the non-reproduced pattern resulting from a change in the size of the outline of each pixel (the reproduced pattern in FIG. 5).

FIG. 8 is a graph showing a change in the overall concentration of each of the reproduced pattern and the non-reproduced pattern resulting from a change in the size of the outline of each pixel (the reproduced pattern in FIG. 6).

FIG. 9A is an explanatory diagram illustrating examples of a non-reproduced pattern and a reproduced pattern according to a second embodiment.

FIG. 9B is an explanatory diagram illustrating different examples of the non-reproduced pattern and the reproduced pattern according to the second embodiment.

FIG. 10 is an explanatory diagram illustrating examples of a non-reproduced pattern and a reproduced pattern according to a third embodiment.

FIG. 11 is an explanatory diagram illustrating examples of a non-reproduced pattern and a reproduced pattern according to a fourth embodiment.

### DESCRIPTION OF THE PREFERRED EMBODIMENTS

Hereinafter, the present invention will be described in more detail with reference to the drawings. The following description is an example in all points and should not be construed as limiting the present invention.

### First Embodiment

### Configuration of Image Forming Apparatus

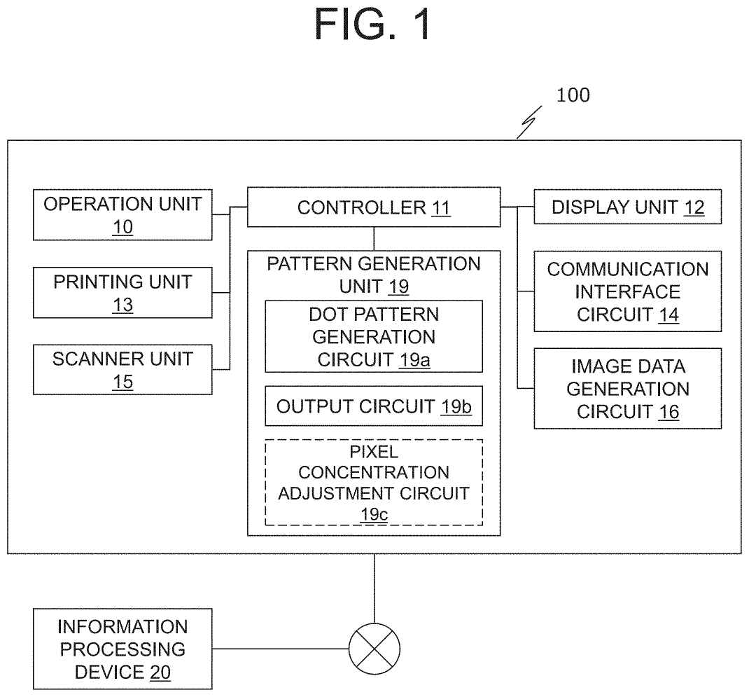

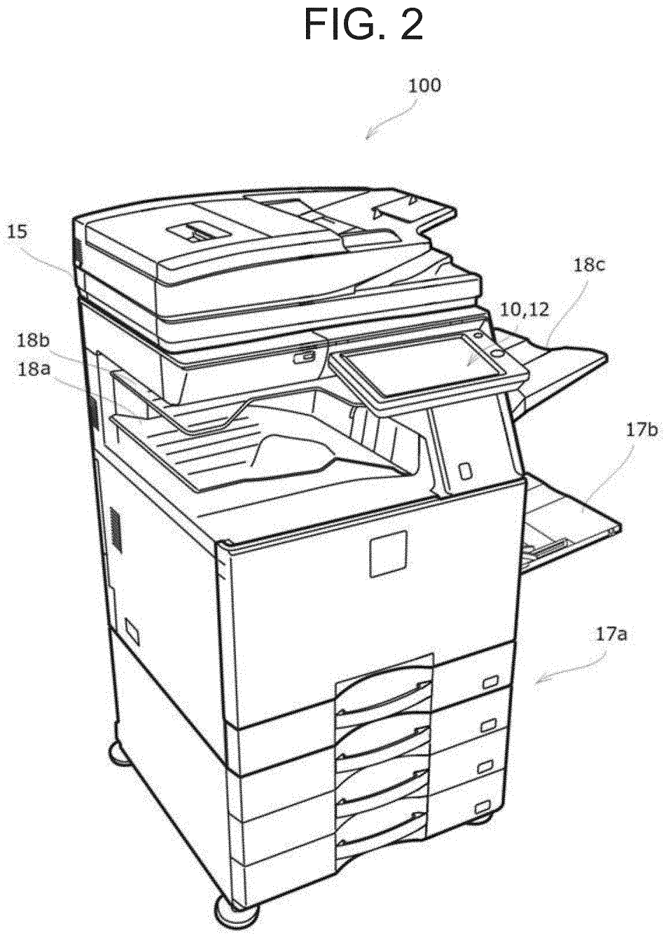

FIG. 1 is a block diagram illustrating a configuration of a digital multifunction peripheral that is an embodiment of an image forming apparatus according to the present embodiment. FIG. 2 is a perspective view of an appearance of the digital multifunction peripheral illustrated in FIG. 1.

It should be noted that although a digital multifunction peripheral is mentioned as an example of the image forming apparatus in the present embodiment, the example of the image forming apparatus is not limited thereto. For example, the image forming apparatus may be any one of a copying machine, a fax machine, and a printer machine, or may be any device related to image formation in addition to these machines.

As illustrated in FIG. 1, the image forming apparatus 100 includes an operation unit 10, a controller 11, a display unit 12, a printing unit 13, a communication interface circuit 14, a scanner unit 15, an image data generation circuit 16, and a pattern generation unit 19.

In addition, the image forming apparatus 100 is coupled to an external information processing device 20 through the communication interface circuit 14. In the present embodiment, the information processing device 20 is a personal computer that stores a document image read by the image forming apparatus 100 and with which a user processes the stored document image. However, the information processing device 20 is not limited to a personal computer but may be, for example, a smartphone or a file server.

In addition, as illustrated in FIG. 2, the image forming apparatus 100 includes a paper feeding tray 17a, paper receiving trays 18a, 18b and 18c, and a bypass tray 17b.

The controller 11 and the printing unit 13, the controller 11 and the scanner unit 15, and the controller 11 and the pattern generation unit 19 are coupled to each other through a bus and can communicate with each other.

The controller 11 controls an operation of each component of the image forming apparatus 100 illustrated in FIG. 1. Specifically, the controller 11 includes, in addition to a main component, a CPU or an MPU (hereinafter, both are collectively referred to as CPU), hardware resources such as a memory, an input/output interface circuit, and a timer circuit.

At least a part of a ROM included in the controller 11 may be a rewritable non-volatile memory. The CPU included in the controller 11 reads a control program stored in the ROM and develops it in the RAM, if necessary. The controller 11 then performs a process according to the control program developed in the RAM.

The CPU causes a display related to a user interface to appear on the display unit 12 in accordance with the content of the control program stored in the ROM and receives an input operation performed with respect to the operation unit 10 by a user. Further, the CPU controls the hardware of the image forming apparatus 100 in accordance with the above-described control program, performing functions such as generation of a tint block pattern and a printing process.

The functions of the controller 11 are performed by running the control program stored in the ROM by the above-described CPU.

The operation unit 10, which is provided on a housing of the image forming apparatus 100, includes a plurality of operation buttons for receiving an operation performed by a user, a touch panel disposed on a display surface of the display unit 12, etc. The controller 11 recognizes a signal indicating the input operation relative to the operation unit 10.

The display unit 12, which includes, for example, a liquid crystal display, displays a variety of pieces of information, images, etc. on the basis of the input received by the operation unit 10, or the like. The controller 11 generates and updates content to be displayed on the display unit 12 and the display unit 12 displays the variety of pieces of information and images, accordingly.

The scanner unit 15, which reads an image of a document, is coupled to the controller 11.

The scanner unit 15 performs an image reading process for copy, fax, and scan jobs under the control of the controller 11. That is, a document image is read and converted into an image signal.

The image data generation circuit 16 generates image data on the basis of the image signal outputted by the scanner unit 15.

The paper feeding tray 17a includes a plurality of trays that individually store pieces of paper with various sizes.

The bypass tray 17b is a tray for feeding pieces of paper with various sizes and of various types.

Under the control of the controller 11, a paper feeding mechanism, which is illustrated in neither FIG. 1 nor FIG. 2, feeds a piece of paper in a designated paper feeding tray into a printing apparatus and delivers it to the printing unit 13.

Under the control of the controller 11, the printing unit 13 prints designated image data onto the piece of paper fed from the paper feeding tray 17a or the bypass tray 17b.

A paper ejecting mechanism, which is illustrated in neither FIG. 1 nor FIG. 2, ejects the piece of paper subjected to printing by the printing unit 13 onto any of the paper receiving trays 18a, 18b, and 18c.

The communication interface circuit 14 is an interface for performing communication with an external device through a network. In the present embodiment, the image forming apparatus 100 communicates with the information processing device 20 coupled thereto through a network. The information processing device 20 stores image data read by the scanner unit 15 and generated by the image data generation circuit 16. Further, the information processing device 20 provides the image data stored therein so that the image data is printed by the printing unit 13.

The pattern generation unit 19 generates a tint block pattern including a reproduced pattern including dots and a non-reproduced pattern also including dots, and outputs the generated tint block pattern to the printing unit 13. The printing unit 13 causes the tint block pattern to be superimposed on the image data generated by the image data generation circuit 16 and printed on paper.

The pattern generation unit 19 includes a dot pattern generation circuit 19a that generates a tint block pattern and an output circuit 19b that outputs the generated tint block pattern to the printing unit 13. The pattern generation unit 19 may also include a pixel concentration adjustment circuit 19c that adjusts the concentration of one pixel constituting the dot pattern, although the pixel concentration adjustment circuit 19c is not an essential component. In FIG. 1, a frame of the pixel concentration adjustment circuit 19c is shown by a chain line to indicate that the pixel concentration adjustment circuit 19c is not essential.

In FIG. 1, the pattern generation unit 19 is defined as one unit included in the image forming apparatus 100, but may be defined as one device that generates and outputs a tint block pattern.

The above is the configuration of the image forming apparatus 100 according to the present embodiment.

### Tint Block Pattern

Description will be made below on a tint block pattern generated by the pattern generation unit 19.

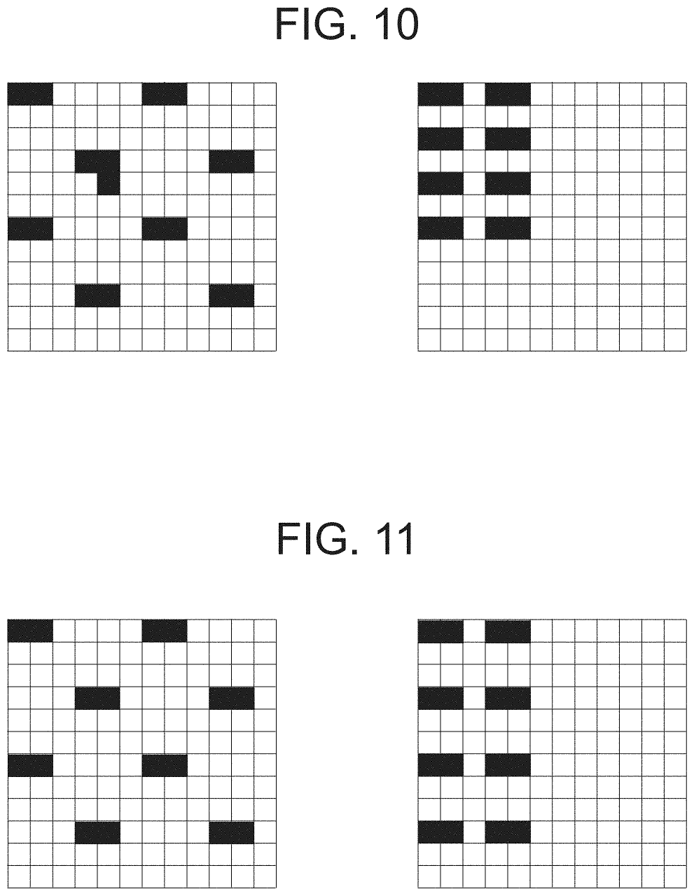

As indicated in the section “Description of the Background Art”, it has been a usual practice that readable-size dots each including a plurality of connected pixels are used as the reproduced pattern (latent portion) and small dots including a smaller number of pixels than those of the reproduced pattern are used as the non-reproduced pattern (background portion). For example, see large dots illustrated in FIG. 11 of Japanese Unexamined Patent Application No. 2007-143111 and small dots illustrated in FIG. 13 of Japanese Unexamined Patent Application No. 2007-143111.

It should be noted that the section “Description of the Background Art” of Japanese Unexamined Patent Application No. 2012-109748 indicates that “the tint block image uses a characteristic of a device ‘the device cannot read dispersed small dots’ due to the limit of a readable resolution. The background portion includes . . . dispersed small dots, and the latent portion includes readable-size dots or dots each including gathered small dots.” However, regarding the “dots each including gathered small dots”, since “the background portion includes dispersed small dots” as described above, it is understood that the “dots each including gathered small dots” of the latent portion are not dispersed. In other words, it is understood that small dots are adjacently arranged with no space therebetween to form large dots. Actually, Japanese Unexamined Patent Application No. 2012-109748 does not describe an embodiment where the latent portion consisting of small dots that do not have to be reproduced when copied.

Meanwhile, Japanese Unexamined Patent Application No. 2007-143111 provides FIGS. 20(a) and (b) as drawings schematically illustrating that concentrated dots (large dots) are reproduced on the copy while dispersed dots (small dots) are not accurately reproduced on the copy. Regarding the “concentrated dots”, it is described that “the dots in the latent portion are generated by a dot-concentrated dither matrix and the dots in the background portion are generated by a dot-dispersed dither matrix.”

Further, in the detailed description of the invention, FIG. 11 of Japanese Unexamined Patent Application No. 2007-143111 illustrates three large dots based on a 4×4 spiral dither matrix (see FIG. 10 of Japanese Unexamined Patent Application No. 2007-143111) as a specific example of the dots generated by the concentrated dither matrix. In addition, FIG. 13 of Japanese Unexamined Patent Application No. 2007-143111 illustrates three small dots based on a 4×4 Bayer dither matrix (see FIG. 12 of Japanese Unexamined Patent Application No. 2007-143111) as a specific example of the small dots generated by the dispersed dither matrix.

However, as in the examples illustrated in FIG. 11 of Japanese Unexamined Patent Application No. 2007-143111, the large dots each include a plurality of dots vertically and horizontally connected to be concentratedly arranged instead of including dispersedly arranged small dots, which are not to be accurately reproduced on the copy.

Further, the reproduced pattern and the non-reproduced pattern are independently determined to cause respective overall concentrations (average concentrations) thereof to be almost equal so that a latent image in the original is less visible. In this case, according to some embodiments, small dots in the non-reproduced pattern are arranged between the patterns with the lower overall concentration, of non-reproduced patterns and reproduced patterns, to cause the overall concentration of the reproduced patterns to be equal to that of the non-reproduced patterns.

Meanwhile, the characteristics of the printing unit 13 fluctuates with a fluctuation in the surrounding environment, deterioration due to use, or the like. A fluctuation in the characteristics of the printing unit 13 with a fluctuation in the surrounding environment, deterioration over time, or the like causes a fluctuation in a concentration of one pixel constituting a dot, consequently, the size of the outline thereof. For example, in a case where the printing unit 13 is of an electrophotographic type, a dot corresponding to one pixel gets fat or thin with a fluctuation in the surrounding environment, deterioration of a photoconductor or a developing agent for image formation, or the like. That is, the size of the dot corresponding to one pixel fluctuates.

Consider the thinning of dots caused in a case where a fluctuation in the characteristics of the printing unit 13 results in a decrease in the concentration of each pixel, making the dots unlikely to be reproduced. For example, small dots each including one pixel tend to get thinner to disappear if the concentration of each pixel decreases from that in an initial state where the respective overall concentrations of the reproduced pattern and the non-reproduced pattern are adjusted to be equal to each other. In contrast, an influence of a decrease in the concentration of each pixel from that in the initial state is not so large for large dots each including, for example, 4×4 pixels, merely causing the large dots to get slightly thinner and smaller.

Inversely, consider a case where an increase in the concentration of each pixel makes the dots likely to be reproduced. Small dots each including one pixel get fatter with an increase in the concentration of each pixel, sometimes becoming, for example, approximately twice as large as the original dots. In contrast, an influence of an increase in the concentration of each pixel from that in the initial state is not so large for large dots each including, for example, 4×4 pixels, merely causing the large dots to get slightly fatter and larger.

That is, a difference in a ratio in size between a portion that gets thinner or fatter and dots in the initial state results in a difference in a degree of a change in overall concentration. Regarding a change in overall concentration with a fluctuation in the size of the outline of each pixel, larger dots in the above-described initial state undergo a smaller degree of a change than smaller dots.

Regarding this problem, the inventors have considered that a factor for a fluctuation in the overall concentration (average concentration) of a region drawn with dots each including one pixel or a plurality of connected pixels is dependency on the original size of the dots and, accordingly, the problem cannot be fundamentally solved as long as large dots and small dots are used.

In other words, large dots, the original size of which is large, and small dots, the original size of which is small, are different from each other in concentration of each of pixels constituting the dots and, consequently, the amount of a change in overall concentration due to a fluctuation in the size of the outline of each of the pixels. It is necessary to perform adjustment to cause the overall concentrations of the reproduced pattern, which includes large dots, and the non-reproduced pattern, which includes small dots, to be substantially the same so that the tint block is less notable on the original. However, considering a fluctuation in the characteristics of the printing unit 13, it is difficult to cause the overall concentrations of the reproduced pattern and the non-reproduced pattern to be always substantially equal to each other.

Regarding a fact that the reproduced pattern and the non-reproduced pattern are different from each other in the degree of a fluctuation in overall concentration resulting from a change in the concentration of each pixel, the findings of the inventors will be briefly described.

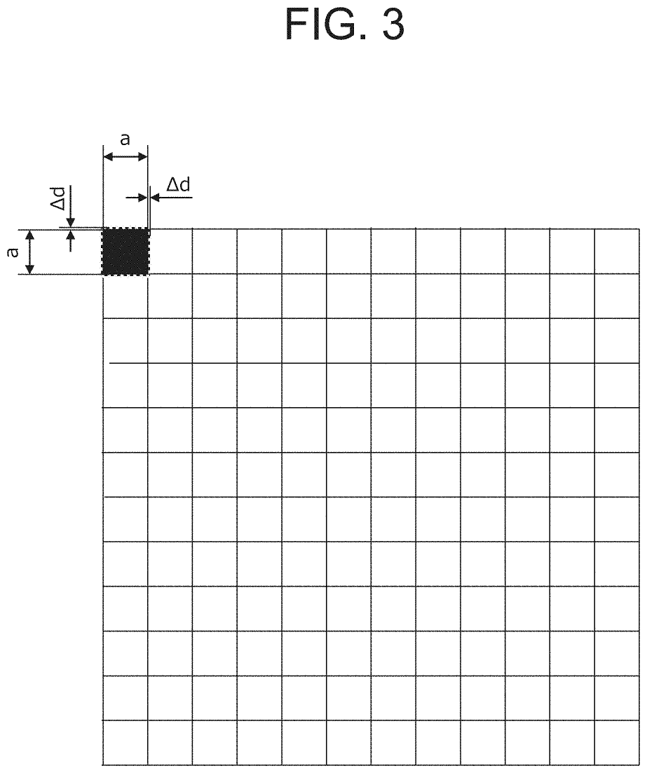

FIG. 3 is an explanatory diagram illustrating an example of one dot including one pixel printed by the printing unit 13 according to the present embodiment. In FIG. 3, one cell of a grid corresponds to one pixel, or the size of a dot. Consider a case where a fluctuation in the characteristics of the printing unit 13 causes each dot to be more intensively printed with the outline of one pixel enlarged by an amount of a portion shown by chain lines around one pixel illustrated in FIG. 3. When a thickness of the enlarged outline is represented by Δd and each side of the one pixel is represented by a, the four sides of the one pixel, or one dot, in FIG. 3 are each increased by a×Δd.

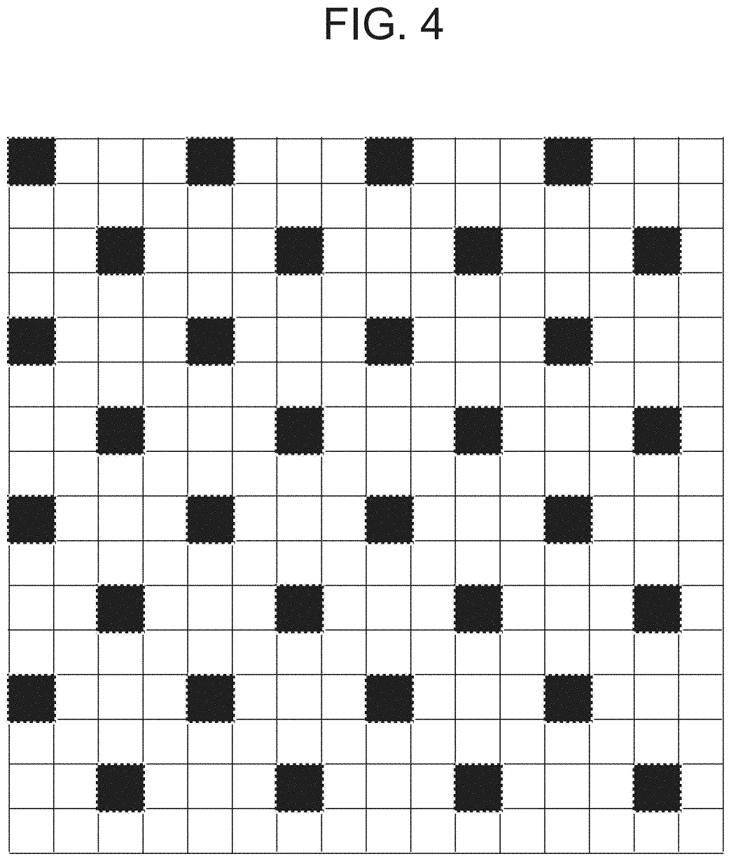

FIG. 4 is an explanatory diagram illustrating an example of a non-reproduced pattern in which dots illustrated in FIG. 3 are dispersed. The total number of the dots in the region illustrated in FIG. 4 is 32.

In a case where a fluctuation in the characteristics of the printing unit 13 causes each pixel to be more intense with the outline of each pixel enlarged as in FIG. 3, an area occupied by the dots is increased by an amount of 32×4×a×Δd=128×a×Δd, since the number of the pixels for the dots is 32 and each pixel has 4 sides shown by chain lines.

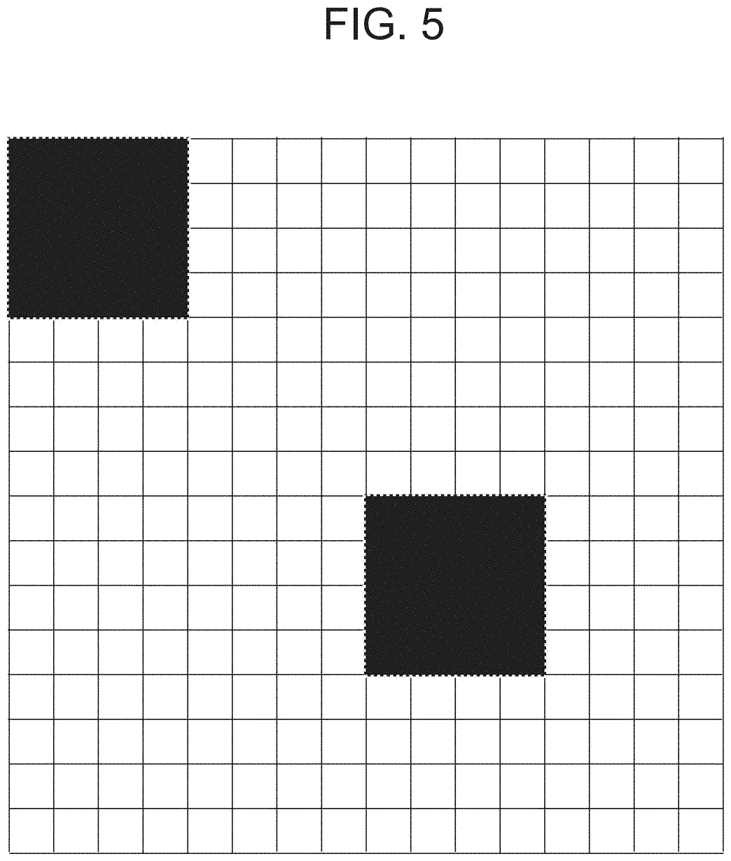

FIG. 5 is an explanatory diagram illustrating an example of a typical reproduced pattern including large dots each including adjacent dots. In FIG. 5, the dots constituting the reproduced pattern each include adjacent pixels in four vertical columns and four horizontal rows. Two dots are arranged in the region illustrated in FIG. 5 so that the overall concentration becomes the same as that in FIG. 4. That is, the total number of pixels constituting the two dots is 32.

In a case where a fluctuation in the characteristics of the printing unit 13 causes each pixel to be more intense with the outline of each pixel enlarged as in FIG. 3, even though the outline enlarges, the outline of each dot does not enlarge at a portion where the pixels are adjacent to each other due to overlap of the adjacent pixels. As shown by chain lines in FIG. 5, the large dots each have a portion where the outline of the dot enlarges on each of the four sides, which is represented by 4×4×a×Δd. The total of those of the two large dots is represented by 32a×Δd. Although a boundary portion where the pixels are adjacent to each other in each of the large dots actually also becomes more intense due to an increase in a toner therein, there is approximately a fourfold change in concentration occurring between FIG. 4 and FIG. 5.

The degree of a change in the overall concentration of the large dots illustrated in FIG. 5 due to a fluctuation in the characteristics of the printing unit 13 is smaller than that of the small dots illustrated in FIG. 4. That is, in a case where a tint block is formed on the original by the reproduced pattern mainly including the large dots and the non-reproduced pattern including small dots, a change in the concentration of each pixel due to a fluctuation in the characteristics of the printing unit 13 causes the respective overall concentrations of the reproduced pattern and the non-reproduced pattern to be different from each other, which makes the tint block easy to see on the original. It is not preferable that the tint block, which should appear only on the copy, is easy to see on the original.

Accordingly, the inventors have reached an idea of forming the reproduced pattern not with large dots including adjacent pixels, but with dots that are substantially the same in size as those of the non-reproduced pattern as in the present embodiment. In this case, the space density of the dots constituting the reproduced pattern is set higher than that of the dots constituting the non-reproduced pattern. The space densities of the dots are differentiated from each other to cause the overall concentrations of the copied reproduced pattern and non-reproduced pattern to be considerably different from each other. Meanwhile, the reproduced pattern and the non-reproduced pattern include the dots that are substantially the same in size not to cause the reproduced pattern and the non-reproduced pattern to be considerably different in a degree of a change in overall concentration from each other even when the characteristics of the printing unit 13 fluctuates.

In the present embodiment, the size of the dots constituting the reproduced pattern and the non-reproduced pattern is small enough to correspond to the limit of the readable resolution of a possible copying machine. However, even when the individual dots have such a size, a group of the dots arranged at a high space density is read, possibly at a lower concentration than connected dots, by the copying machine without disappearing.

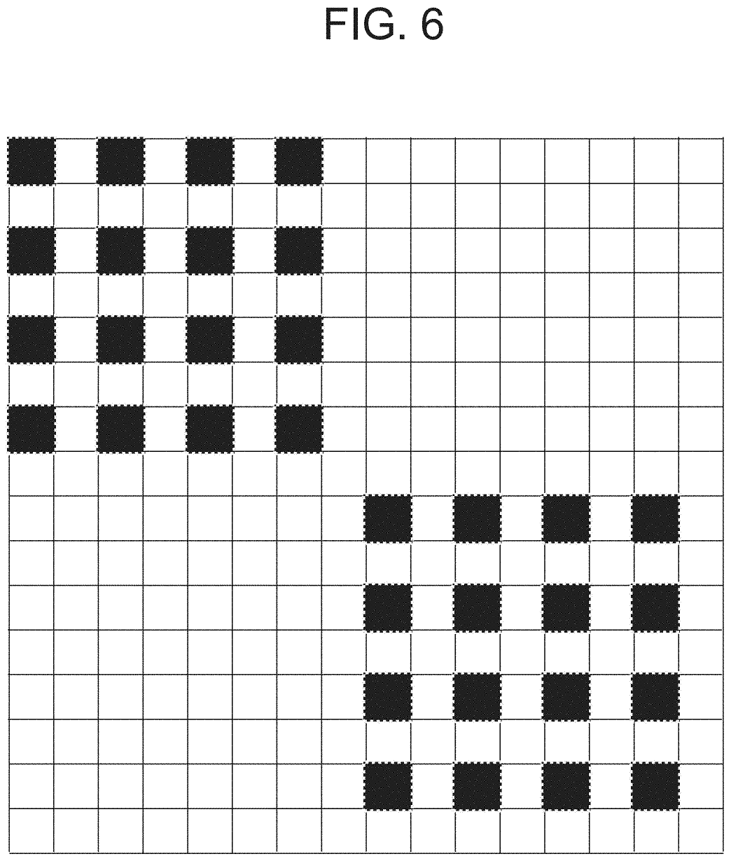

FIG. 6 is an explanatory diagram illustrating an example of the reproduced pattern according to the present embodiment. Compared to the typical reproduced pattern illustrated in FIG. 5 and the non-reproduced pattern illustrated in FIG. 4, a pattern corresponding to each of the large dots in FIG. 5 is formed by a group of dots with the same size as those of the non-reproduced pattern arranged at a high space density. In the present embodiment, for example, the group of dots arranged at a high space density as in FIG. 6, which corresponds to the large dot in FIG. 5, is referred to as an effective large dot.

In a case where a fluctuation in the characteristics of the printing unit 13 causes each pixel to be more intense with the outline of each pixel enlarged as in FIG. 3, the area occupied by the dots is increased by 128×a×Δd as in FIG. 4, since there are 32 pixels for the dots, and each pixel has 4 sides shown by chain lines. That is, a change in the overall concentration of the reproduced pattern illustrated in FIG. 6 is equal to the change in the overall concentration of the non-reproduced pattern illustrated in FIG. 4.

As described above, the reproduced pattern according to the present embodiment includes the effective large dots including dots that are substantially the same in size as those used for the non-reproduced pattern. The reproduced pattern and the non-reproduced pattern are distinguished from each other by not a difference in dot size but a difference in space density.

### Characteristics of Change in Overall Concentration

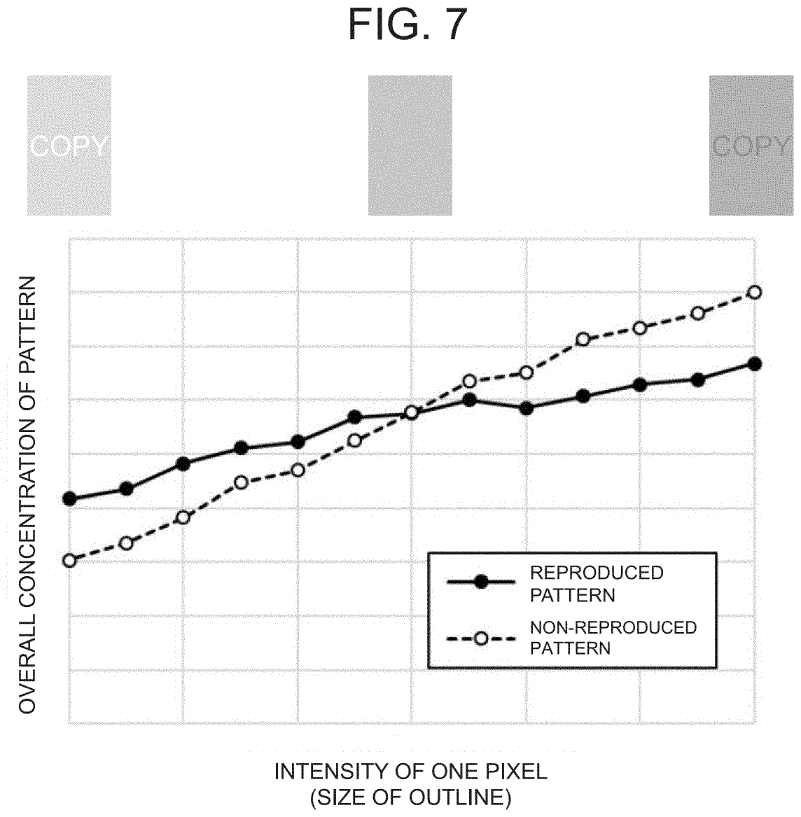

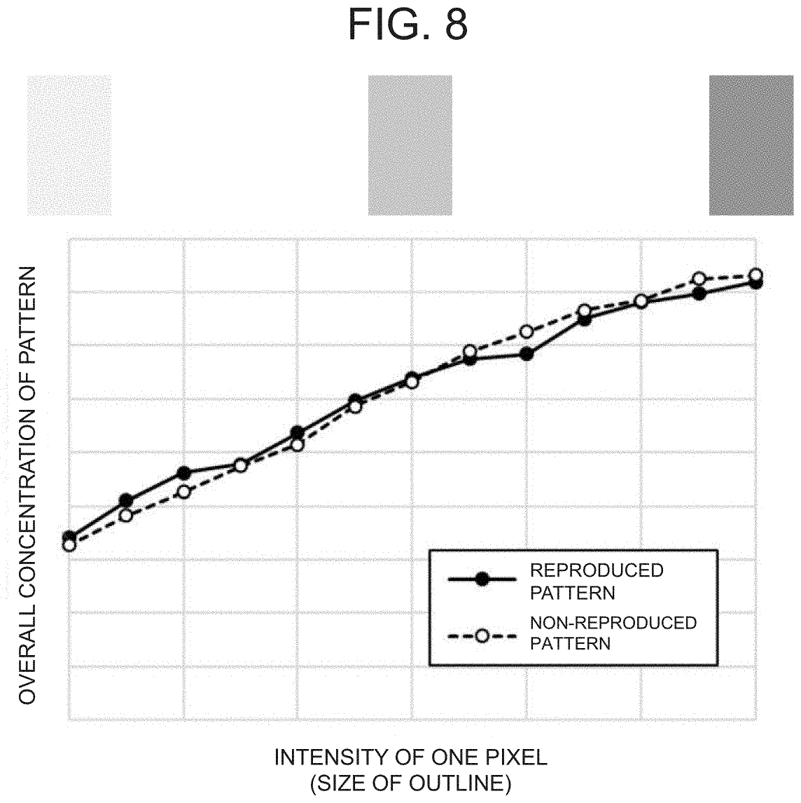

Each of FIG. 7 and FIG. 8 is a graph showing a change in the overall concentration of each of the reproduced pattern and the non-reproduced pattern resulting from a change in the size of the outline of each pixel with a fluctuation in the intensity of each pixel.

In the graph in FIG. 7, the reproduced pattern is a pattern where a plurality of large dots are arranged in a way as illustrated in FIG. 5 and the non-reproduced pattern is a pattern where a plurality of dots are arranged in a way as illustrated in FIG. 4. That is, FIG. 7 illustrates an example of the characteristics of a tint block pattern on the original according to a typical technology. The abscissa axis represents the size of the outline of each pixel and the ordinate axis represents the overall concentration of each of the reproduced pattern and the non-reproduced pattern.

A graph in FIG. 8 is the same as that in FIG. 7 except that the reproduced pattern where dots are arranged in a way as illustrated in FIG. 6 is used. FIG. 8 illustrates an example of the characteristics of a tint block pattern on the original according to the present embodiment.

FIG. 7 and FIG. 8 each illustrate an example of an appearance of the tint block pattern on the original corresponding to each of a minimum value, a median value, and a maximum value of the abscissa axis of the graph. In the tint block pattern corresponding to each of the minimum value and the maximum value in FIG. 7, a difference in concentration between the reproduced pattern and the non-reproduced pattern causes the tint block pattern, i.e., “COPY”, to appear on the original. In contrast, in the tint block pattern corresponding to each of the minimum value and the maximum value in FIG. 8, a difference in concentration between the reproduced pattern and the non-reproduced pattern is not substantially different from a difference in concentration at the median value, not causing the tint block pattern to appear on the original.

### Second Embodiment

In the first embodiment, the reproduced pattern and the non-reproduced pattern are each drawn with a group of one-pixel dots, but each of the dots does not necessarily consist of one pixel.

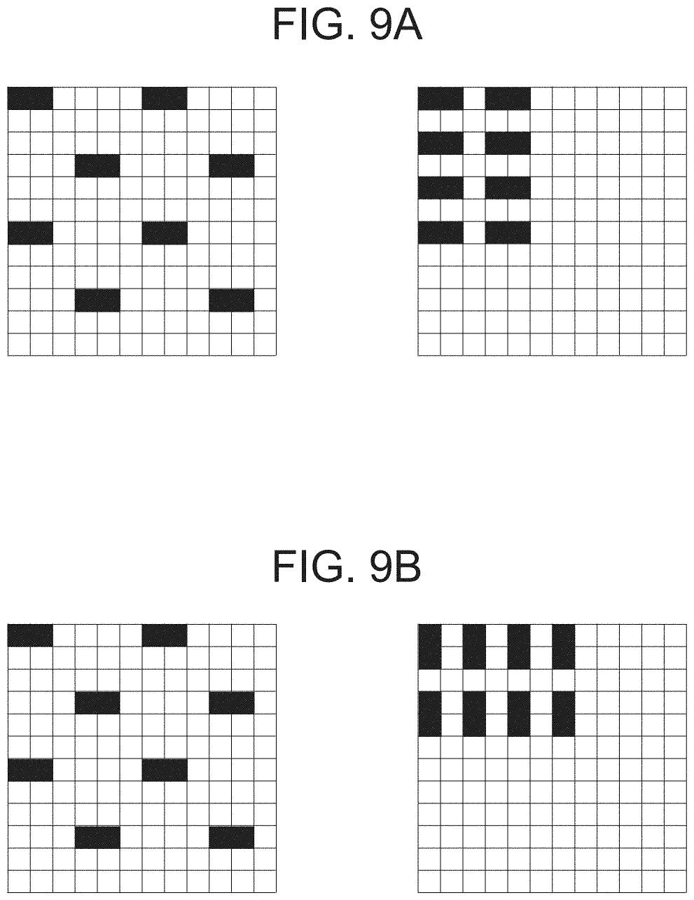

For example, as illustrated in FIG. 9A and FIG. 9B, one dot may include adjacent two pixels. However, it is very preferable that the reproduced pattern and the non-reproduced pattern both include the same dots.

FIG. 9A illustrates an example of the non-reproduced pattern at the left and an example of the reproduced pattern including an effective large dot at the right. In the examples in FIG. 9A, directions for the two pixels of the individual dots to be arranged are all the same (for example, a horizontal direction).

In FIG. 9B, the non-reproduced pattern is the same as that in FIG. 9A, where the two pixels of the individual dots are arranged in the horizontal direction. Meanwhile, the effective large dot of the reproduced pattern includes dots each including two pixels arranged in a vertical direction.

### Third Embodiment

In the first and second embodiments, the reproduced pattern and the non-reproduced pattern both include the groups of dots that are the same in shape.

However, the dots are not necessarily all the same in shape but a part of the dots may be different in shape.

FIG. 10 illustrates a reproduced pattern and a non-reproduced pattern that are basically the same as those in FIG. 9A but a part of the dots of the non-reproduced pattern is different in shape from the other dots. That is, of the dots of the non-reproduced pattern illustrated in FIG. 10, one dot includes three adjacent pixels.

A percentage of inclusion of such a different dot only has to be 40% or less and is preferably 10% or less of the total number of the dots constituting the reproduced pattern or the non-reproduced pattern, more preferably 5% or less, further preferably 1% or less.

### Fourth Embodiment

In the first to third embodiments, a dot-to-dot distance in the group of dots constituting the reproduced pattern is a minimum distance, i.e., one pixel, but the distance is not limited to one pixel. The distance only has to achieve a space density sufficient for the group of dots not to disappear when read by a possible copying machine.

FIG. 11 illustrates a pattern where dots each including two pixels adjacent in the horizontal direction are arrange in four vertical columns and two horizontal rows as in the reproduced pattern illustrated in FIG. 9A. However, in the effective large dot included in the reproduced pattern, the dots are arranged side by side in the vertical direction at a distance of two pixels.

### Fifth Embodiment

As described in the first to fourth embodiments, in a case where the reproduced pattern includes the group of dots, a fluctuation in the characteristics of the printing unit 13 causes the concentrations of the reproduced pattern and the non-reproduced pattern to substantially equally change as shown in, for example, FIG. 8. Accordingly, a function to manually adjust the concentration of one pixel generating the tint block pattern is basically not necessary. However, the function to manually adjust the concentration of one pixel generating the tint block pattern may be provided as in a typical manner.

In a case where the function to manually adjust the concentration of one pixel is provided, it is favorable that a test pattern for adjustment is printed by the printing unit 13 and the concentration of one pixel is set to make the reproduced pattern likely to be reproduced and the non-reproduced pattern unlikely to be reproduced when the test pattern is copied.

As described above,

(i) a pattern generation device according to the present invention includes: a dot pattern generation circuit that generates, with dots each including one pixel and/or a plurality of connected pixels, a tint block pattern from an adjacent dot pattern to a reproduced pattern where the dots are reproduced when copied and a non-reproduced pattern where the dots are unlikely to be reproduced when copied as compared with in the reproduced pattern; and an output circuit that provides the generated tint block pattern to a printing unit that prints an image, in which the reproduced pattern includes an effective large dot region where the dispersed dots are arranged at a higher space density than in the non-reproduced pattern.

In the present invention, a pixel is the smallest unit that constitutes image data. The printing unit basically prints a group of points corresponding to the pixels that constitute the image data on paper. Actually, the printing includes a complicated process for obtaining a beautiful and precise image.

Further, each dot is a mass of isolated points each including one pixel or a plurality of pixels. A dot including connected pixels refers to a dot including adjacent pixels.

Moreover, the dot pattern refers to a pattern including a plurality of dots.

A specific example of the reproduced pattern is the dot pattern illustrated in FIG. 6. A specific example of the effective large dot region is the region where dots are arranged in four vertical columns and four horizontal rows at one-pixel distances in FIG. 6. A specific example of the non-reproduced pattern is the dot pattern illustrated in FIG. 4.

The tint block pattern refers to a woven pattern including the reproduced pattern and the non-reproduced pattern.

The type of the printing unit is not limited as long as it prints an image. A specific embodiment of the printing unit is, for example, an electrophotographic image forming apparatus (but excluding a component that generates a tint block pattern). The digital multifunction peripheral in the above-described embodiment corresponds to the printing unit according to the present invention.

Further, the space density refers to a concept corresponding to a space density on the paper where the tint block pattern is printed.

The effective large dot region refers to a region where the dispersed dots are arranged at a high space density, i.e., a region where dots, such as large dots each including a lot of connected pixels, are likely to be reproduced when copied.

An example of a specific embodiment of the pattern generation device according to the present invention is the pattern generation unit in FIG. 1.

Furthermore, preferred embodiments of the present invention will be described.

(ii) The dispersed dots may be arranged at least at a one-pixel distance from the dots adjacent thereto in the effective large dot region.

In this regard, since the effective large dot region includes the dispersed dots as the non-reproduced pattern, it is possible to provide the tint block pattern where a fluctuation or a variation in the concentration of each pixel is unlikely to have an influence on a difference in concentration between the reproduced pattern and the non-reproduced pattern.

(iii) The dots may each include three or less connected pixels or one pixel.

In this regard, since the reproduced pattern includes the dispersed dots each including three or less connected pixels or one pixel as the non-reproduced pattern, it is possible to provide the tint block pattern where a fluctuation or a variation in the concentration of each pixel is unlikely to have an influence on a difference in concentration between the reproduced pattern and the non-reproduced pattern.

(iv) The reproduced pattern may include the dots each including two connected pixels or one pixel.

In this regard, since the reproduced pattern includes the dispersed dots each including two pixels or one pixel, it is possible to provide the tint block pattern where a fluctuation or a variation in the concentration of each pixel is unlikely to have an influence on a difference in concentration between the reproduced pattern and the non-reproduced pattern.

(v) The dots each including the two connected pixels in the reproduced pattern may each be provided by arranging the two pixels side by side in the same direction.

In this regard, since the dots each including the two connected pixels in the reproduced pattern are each provided by arranging the two pixels side by side in the same direction, it is possible to provide the reproduced pattern where the dots are arranged side by side at narrow distances, i.e., at a high space density.

(vi) At least one of the effective large dot region or the non-reproduced pattern may be a dot pattern including two or more types of dots different in shape.

In this regard, each of the effective large dot region and the non-reproduced pattern can include a variety of dots.

(vii) The reproduced pattern may include the dots having the same shape as the dots in the non-reproduced pattern.

In this regard, it is possible to generate the reproduced pattern and the non-reproduced pattern with dots having the same shape.

(viii) The pattern generation device may further include a pixel concentration adjustment circuit that adjusts the concentration of one pixel that is a constituent unit for the dots.

In this regard, in a case where the overall concentrations of the reproduced pattern and the non-reproduced pattern are different from each other, the difference can be adjusted to be smaller by the pixel concentration adjustment circuit.

(ix) Additionally, the preferred embodiments of the present invention include an image forming apparatus including: the pattern generation device; and a printing unit that prints an image including the tint block pattern generated by the pattern generation device.
(x) Additionally, the preferred embodiments of the present invention include a pattern generation method including: by a computer, causing a pattern generation device to generate, with dots each including one pixel and/or a plurality of connected pixels, a tint block pattern by using an adjacent dot pattern to a reproduced pattern where the dots are to be reproduced when copied and a non-reproduced pattern where the dots are unlikely to be reproduced when copied as compared with in the reproduced pattern; and causing a printing unit to print an image of the generated tint block pattern, in which the reproduced pattern is a dot pattern including an effective large dot region where the dispersed dots are arranged at a higher space density than in the non-reproduced pattern.
(xi) Further, the preferred embodiments of the present invention include a pattern forming device including: a dot pattern generator that generates, with dots each including one pixel and/or a plurality of pixels, a tint block pattern having a reproduced region where the dots are reproduced when copied and a non-reproduced region where the dots are unlikely to be reproduced when copied as compared with the reproduced region, the tint block pattern including a reproduced pattern in the form of a pattern including the plurality of dots and formed in the reproduced region and a non-reproduced pattern in the form of a pattern including the plurality of dots and formed in the non-reproduced region; and an image forming section that forms the generated tint block pattern into an image, in which the reproduced pattern and the non-reproduced pattern include dots having the same shape, and the a dot-to-dot distance in the reproduced pattern is smaller than a dot-to-dot distance in the non-reproduced pattern.

In the embodiment described in (xi), the reproduced region is a region including the reproduced pattern and a non-reproduced region is a region including the non-reproduced pattern. The reproduced pattern and the non-reproduced pattern are different in dot pattern from each other but both the patterns are similar in that they each include a plurality of dots. A specific example of the reproduced region is the dot pattern illustrated in FIG. 6. A specific example of the non-reproduced region is the dot pattern illustrated in FIG. 4.

Further, an example of a specific embodiment of the dot pattern generator is the pattern generation unit illustrated in FIG. 1 and an example of a specific embodiment of the image forming section is the printing unit illustrated in FIG. 1.

The preferred embodiments of the present invention also include a combination of any of the above-described plurality of embodiments.

Various modifications of the present invention are possible in addition to the above-described embodiments. These modifications should not be understood as not belonging to the scope of this invention. The present invention includes the meaning equivalent to the claims and all modifications within the scope.

### REFERENCE SIGNS LIST

10: operation unit, 11: controller, 12: display unit, 13: printing unit, 14: communication interface circuit, 15: scanner unit, 16: image data generation circuit, 17a: paper feeding tray, 17b: bypass tray, 18a, 18b, 18c: paper receiving tray, 19: pattern generation unit, 19a: dot pattern generation circuit, 19b: output circuit, 19c: pixel concentration adjustment circuit, 20: information processing device, 100: image forming apparatus

What is claimed is:

1. A pattern generation device comprising:
a dot pattern generation circuit that generates, with dots each including one pixel and/or a plurality of connected pixels, a tint block pattern by using an adjacent dot pattern to a reproduced pattern where the dots are reproduced when copied and a non-reproduced pattern where the dots are unlikely to be reproduced when copied as compared with in the reproduced pattern; and
an output circuit that provides the generated tint block pattern to a printing unit that prints an image, wherein
the reproduced pattern includes an effective large dot region where the dispersed dots are arranged at a higher space density than in the non-reproduced pattern.

2. The pattern generation device according to claim 1, wherein the dispersed dots are arranged at least at a one-pixel distance from the dots adjacent thereto in the effective large dot region.

3. The pattern generation device according to claim 1, wherein the dots each include three or less connected pixels or one pixel.

4. The pattern generation device according to claim 3, wherein the reproduced pattern includes the dots, each including two connected pixels or one pixel.

5. The pattern generation device according to claim 4, wherein the dots, each including the two connected pixels in the reproduced pattern, are each provided by arranging the two pixels side by side in a same direction.

6. The pattern generation device according to claim 1, wherein at least one of the effective large dot region or the non-reproduced pattern is a dot pattern including two or more types of dots different in shape.

7. The pattern generation device according to claim 6, wherein the reproduced pattern includes the dots having a same shape as the dots in the non-reproduced pattern.

8. The pattern generation device according to claim 1, further comprising a pixel concentration adjustment circuit that adjusts a concentration of one pixel that is a constituent unit for the dots.

9. An image forming apparatus comprising:
the pattern generation device according to claim 1; and
a printing unit that prints an image including the tint block pattern generated by the pattern generation device.

10. A pattern generation method comprised by:
a computer,
causing a pattern generation device to generate, with dots each including one pixel and/or a plurality of connected pixels, a tint block pattern by using an adjacent dot pattern to a reproduced pattern where the dots are to be reproduced when copied, and a non-reproduced pattern where the dots are unlikely to be reproduced when copied, as compared with in the reproduced pattern; and
causing a printing unit to print an image of the generated tint block pattern, wherein
the reproduced pattern includes an effective large dot region where the dispersed dots are arranged at a higher space density than in the non-reproduced pattern.
